(19) United States
(12) Patent Application Publication
(10) Pub. No.: US 2026/0340380 A1
(43) Pub. Date: Oct. 29, 2026

(54) MANAGEMENT OF BIAS IN GENERATIVE ARTIFICIAL INTELLIGENCE (AI) MODELS

(71) Applicant: Dell Products L.P., Round Rock, TX (US)

(72) Inventors: OFIR EZRIELEV, Be'er Sheva (IL); HANNA YEHUDA, Acton, MA (US); ANNE-MARIE MCREYNOLDS, San Jose, CA (US)

(21) Appl. No.: 19/191,672

(22) Filed: Apr. 28, 2025

(51) Int. Cl. G06N 3/08

(52) U.S. Cl. CPC G06N 3/08

(57) ABSTRACT

Methods and systems for providing computer-implemented services using generative AI models are disclosed. An identification of an occurrence of a bias correction event for a generative AI model pipeline (based on a generative AI model of the generative AI models) may be made. Based on the identification, information content to un-inference for may be identified in the generative AI model pipeline. The generative AI model pipeline may be updated based on the information content so that outputs generated by the updated generative AI model pipeline are less influenced by the information content. Using the updated generative AI model pipeline, a second output may be obtained, and a portion of the computer-implemented services may be provided using at least the second output.

### FIELD

Embodiments disclosed herein relate generally to providing computer-implemented services using generative artificial intelligence (AI) models. More particularly, embodiments disclosed herein relate to managing bias in generative AI models.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIG. 2A shows a first flow diagram illustrating data flows in accordance with an embodiment.

FIGS. 2B-2E show an example graphical user interface (GUI) and an example generative AI session in accordance with an embodiment.

FIG. 2F shows a second flow diagram illustrating data flows in accordance with an embodiment.

FIG. 3 shows a flow diagram illustrating a method for providing computer-implemented services using generative AI models in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for providing computer-implemented services using generative AI models. The generative AI models may include large language models (LLMs) that may generate outputs (e.g., responses) when provided with prompts. The outputs may be used, at least in part, to provide the computer-implemented services. For example, the outputs may be provided to a downstream consumer and the downstream consumer may use the outputs to make decisions.

The outputs may be provided to downstream consumers as part of generative AI sessions (e.g., chat sessions) with the downstream consumers. A generative AI session may include any exchange of prompts from a first entity (e.g., a downstream consumer) and outputs from a second entity (e.g., a generative AI model). For example, a chat session may be initiated by a downstream consumer (e.g., a client, a customer) via a graphical user interface (GUI). The customer may enter a prompt, which may be displayed in a chat window of the GUI. The prompt may be used as ingest for a generative AI model and the output generated by the generative AI model may be added to the chat window as a response from a chat agent (e.g., a virtual assistant). The downstream consumer may enter additional prompts during the chat session and all prompts and outputs may be recorded on the chat window during the chat session.

The generative AI models may generate new outputs based on all components of the chat history (e.g., all prompts and outputs during the chat session). Therefore, if the chat session includes erroneous, outdated, and/or otherwise undesired information content, then the downstream consumer may be required to terminate the existing chat session and initiate a new chat session to avoid receiving outputs that do not meet their expectations. For example, the outputs may not meet their expectations due to being may be inaccurate, irrelevant, and/or biased.

For example, the outputs may be biased due to biases in training data used to train the generative AI models. Managing bias in the generative AI models may require rigorous testing of model outputs, human oversight, and/or re-training (e.g., using appropriately diverse training data), which may be resource intensive. Despite these types of debiasing efforts, the generative AI models may continue to provide biased outputs with respect to personal values of the downstream consumer.

Therefore, to increase a likelihood of providing outputs that meet the expectations of the user, active debiasing functionality may be provided using un-inferencing during the chat session. For example, the downstream consumer may initiate a bias correction event indicating that an output from the generative AI model pipeline expresses undesirable levels of bias (e.g., based on the personal values of the downstream consumer). To do so, the downstream consumer may identify information content of the generative AI session history to un-inference. In response, a generative AI model pipeline based on the generative AI model (e.g., an executing instance of the generative AI model) may be updated so that outputs generated by the updated generative AI model pipeline are less influenced by the information content.

For example, to un-inference the information content, the information content may be negated by providing negative information content (or other negating information) to the generative AI model pipeline (e.g., removing the information content from the generative AI session history), thereby reducing a bias (e.g., indicated by the downstream consumer) expressed by the information content for subsequent outputs generated via the generative AI model pipeline.

Thus, embodiments disclosed herein may provide an improved method for providing computer-implemented services using generative AI models. To provide the computer-implemented services as desired by downstream consumers, a means for active management of bias in outputs of generative AI model pipelines may be provided. For example, the downstream consumer may actively identify and correct for biases in the outputs via un-inferencing of information content from a current chat session.

By doing so, outputs obtained from the generative AI model pipeline may be more likely to be reliable for use by the downstream consumer. In addition, by providing functionality for active management of biases in outputs of the generative AI model pipeline, reliable outputs may be provided timely, and resources required to otherwise manage bias in generative AI models may be conserved.

In an embodiment, a method for providing computer-implemented services using generative AI models is provided. The method may include making an identification of an occurrence of a bias correction event for a generative AI model pipeline based on a generative AI model of the generative AI models, and based on the identification: identifying information content to un-inference for in the generative AI model pipeline; updating the generative AI model pipeline based on the information content so that outputs generated by the updated generative AI model pipeline are less influenced by the information content; obtaining, using the updated generative AI model pipeline, a second output; and, providing a portion of the computer-implemented services using at least the second output.

Updating the generative AI model pipeline may include adding, based on the information content, embeddings corresponding to the information content to the generative AI model pipeline.

Updating the generative AI model pipeline may include adding, based on the information content, a negation layer as an adjunct for the generative AI model to the generative AI model pipeline.

Updating the generative AI model pipeline may include adding, based on the information content, a negation layer as an adjunct for the generative AI model that feeds into an attention module of the generative AI model pipeline.

Updating the generative AI model pipeline may include adding, based on the information content, a negation layer as an adjunct for a hidden layer of an attention module of the generative AI model pipeline.

The bias correction event may be a request indicating that a first output from the generative AI model pipeline expresses undesirable levels of bias.

The request may be from a user that provided a prompt for which the first output was generated.

The bias correction event may be an initiation of use of the generative AI model pipeline, and a blueprint for the generative AI model pipeline may require active debiasing of outputs generated by the generative AI model pipeline.

The updated generative AI model pipeline may treat the information content as negative information content during generation of the second output.

The information content may be defined, at least in part, by a statement regarding a bias, and a negative information attribution to the information content.

The negative information attribution may indicate that the information content is to be un-inferenced.

The generative AI model may be a large language model (LLM).

In an embodiment, a non-transitory media is provided. The non-transitory media may include instructions that when executed by a processor cause the computer-implemented method to be performed.

In an embodiment, a system is provided. The system may include the non-transitory media and a processor, and may perform the computer-implemented method when the computer instructions are executed by the processor.

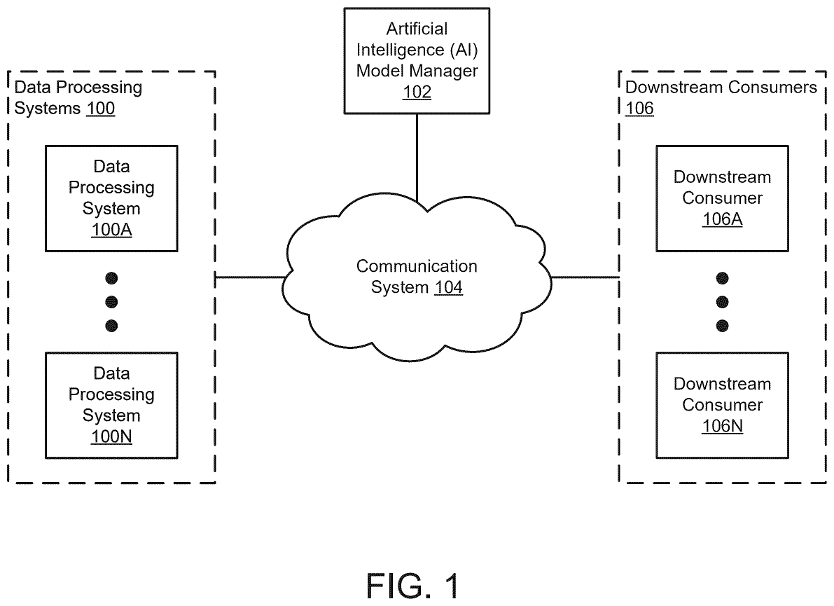

Turning to FIG. 1, a block diagram illustrating a system in accordance with an embodiment is shown. The system shown in FIG. 1 may provide for management of data processing systems that may provide, at least in part, computer-implemented services (e.g., to users of the system and/or devices operably connected to the system).

The computer-implemented services may include any type and quantity of computer-implemented services. The computer-implemented services may include, for example, database services, data processing services, electronic communication services, inference generation services, and/or any other services that may be provided using one or more computing devices. The computer-implemented services may be provided by, for example, data processing systems 100, AI model manager 102, downstream consumers 106, and/or any other type of devices (not shown in FIG. 1). Other types of computer-implemented services may be provided by the system shown in FIG. 1 without departing from embodiments disclosed herein.

The computer-implemented services may be provided, at least in part, using generative AI models and/or outputs obtained using the generative AI models. To do so, data processing systems 100 and/or AI model manager 102 may host any number of generative AI models.

To obtain the outputs, the generative AI models may be trained, using training data, to generate the outputs when provided with prompts (e.g., ingest data). The generative AI models may include large language models (LLMs) and, therefore, the outputs may include new instances of data created by the generative AI models based on learned associations from and/or an understanding of the training data. For example, the generative AI models may be trained using unstructured data, such as stories, essays, audio transcription, video description, and/or other types of human interpretable text, to generate outputs of the same. The outputs may be provided to downstream consumers 106 (e.g., client devices, data processing systems that manage computer systems and/or production systems) as part of providing the computer-implemented services.

The outputs may be provided to downstream consumers 106 as part of generative AI sessions (e.g., chat sessions) with downstream consumers 106. A chat session may include, for example, a real-time interaction between two entities (e.g., a downstream consumer and an AI agent) during which information is exchanged. The information may include prompts provided by the downstream consumer and outputs generated by a generative AI model. The prompts and the outputs may include any type of data modality (e.g., images, audio, video, text).

A chat session may be accessed by a downstream consumer (e.g., 106A) via a graphical user interface (GUI) used as part of, for example, a customer support service, a data analysis service, a content creation service, and/or other services. Downstream consumer 106A may provide a prompt and the AI agent may provide an output that is responsive to the prompt. The AI agent may include a software program that manages, at least in part, operation of the generative AI model and that serves as a proxy for the generative AI model in a simulated conversation with the downstream consumer during the chat session. The generative AI model may use all previous prompts and all previously generated outputs to generate each additional output as part of the chat session.

However, outputs provided by the generative AI model (e.g., a generative AI model pipeline based on the generative AI model) may not be reliable for use by downstream consumers 106. For example, the outputs may be erroneous, irrelevant, and/or biased. For example, downstream consumer 106A may provide erroneous, irrelevant, and/or otherwise undesired information content to the chat session via a prompt, which may negatively affect subsequent outputs obtained during the chat session.

In addition, the outputs may be biased, for example, due to the generative AI model being trained using inadequate (e.g., biased) training data and/or training methods, and as a result of the inadequate training, the generative AI model may generate outputs with biased information content. To manage bias in outputs of generative AI models, rigorous testing of the outputs and/or re-training (e.g., obtaining and using appropriately diverse training data) may be required, which may be resource intensive and may require human oversight. Even then, the generative AI models may provide outputs that are considered biased based on personal values of downstream consumer 106A (which may not be shared by downstream consumer 106N).

As a result, the outputs may be likely to include inaccurate, irrelevant, and/or biased information, and therefore may fail to meet the expectations of downstream consumer 106A. Thus, functionality for active debiasing of the generative AI model may be provided.

In general, embodiments disclosed herein may provide methods, systems, and/or devices for active management of bias in outputs of generative AI models. To do so, functionality for un-inferencing information content may be provided to downstream consumer 106A. For example, downstream consumer 106A may identify a bias in the generative AI model (e.g., based on information content of an output from the generative AI model and/or based on prior knowledge of the generative AI model), and information content describing the bias may be un-inferenced for. As a result, the generative AI model pipeline may be updated based on the information content so that outputs generated by the updated generative AI model pipeline are less influenced by the information content.

The information content may be defined, at least in part, by a statement regarding a bias (e.g., provided by the downstream consumer or other entity) and a negative information attribution indicating that the information content is to be un-inferenced. The generative AI model pipeline may be updated to treat the information content as negative information content during generation of subsequent outputs based on embeddings and/or negation layers provided as adjuncts for the generative AI model. By doing so, bias (including subjective bias) in outputs from the generative AI model pipeline may be actively managed by un-inferencing biased information content of a generative AI session.

Thus, embodiments disclosed herein may improve processes for managing bias in generative AI models that are used to provide computer-implemented services to downstream consumers.

To provide the above noted functionality, the system of FIG. 1 may include data processing systems 100, AI model manager 102, downstream consumers 106, and communication system 104. Each of these components is discussed below.

Data processing systems 100 may provide all, or a portion of, the computer-implemented services. Data processing systems 100 may include any number of data processing systems (e.g., 100A-100N) that may provide output generation services to downstream consumers 106. For example, a downstream consumer (e.g., 106A) may subscribe to output generation services provided by data processing system 100A and downstream consumer 106A may provide prompts (e.g., from clients, from owners of downstream consumer 106A, from employees of a company that owns downstream consumer 106A) to data processing system 100A as part of the subscribed services.

As part of providing the computer-implemented services, data processing systems 100 may: (i) obtain prompts for generative AI models (e.g., hosted and/or operated by data processing systems 100), (ii) feed the prompts into a generative AI model to obtain outputs (e.g., via a generative AI model pipeline), and (iii) provide the outputs to downstream consumers as part of providing computer-implemented services to the downstream consumers.

Data processing systems 100 may provide chat session services to downstream consumers 106. For example, one or more of data processing systems 100 may host AI agents that manage chat sessions with users (e.g., downstream consumers). A record of the chat sessions may be displayed, via the GUI, on a user's device (e.g., one or more of downstream consumers 106).

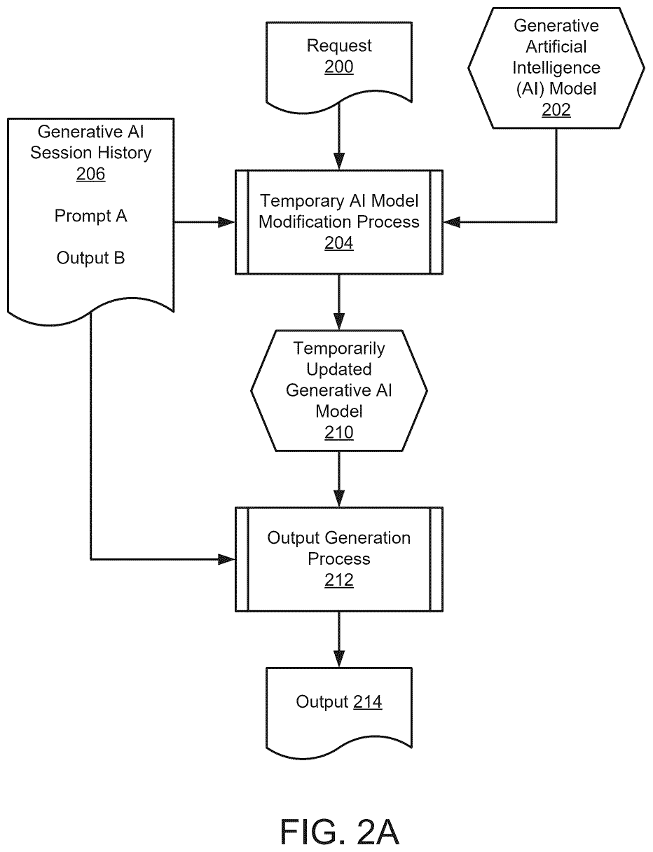

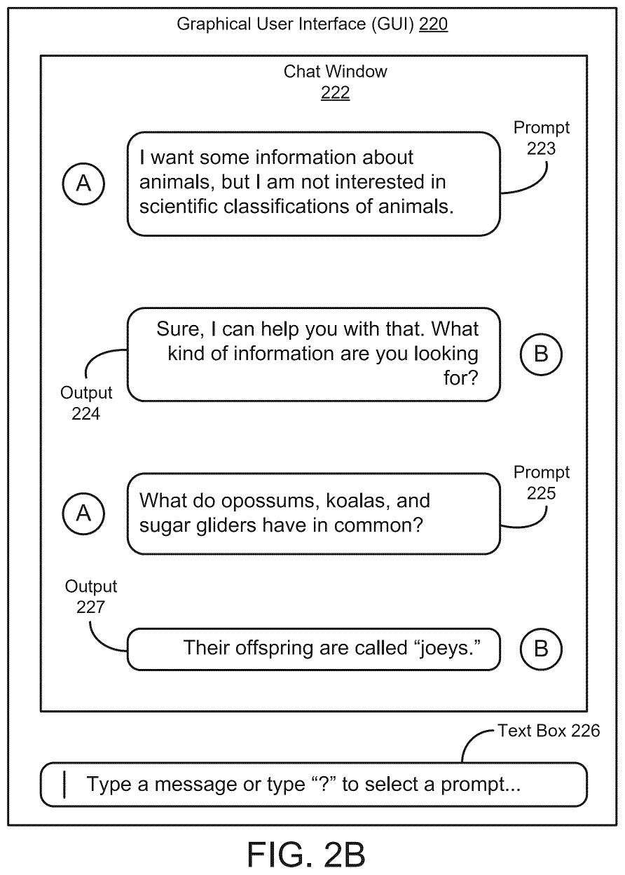

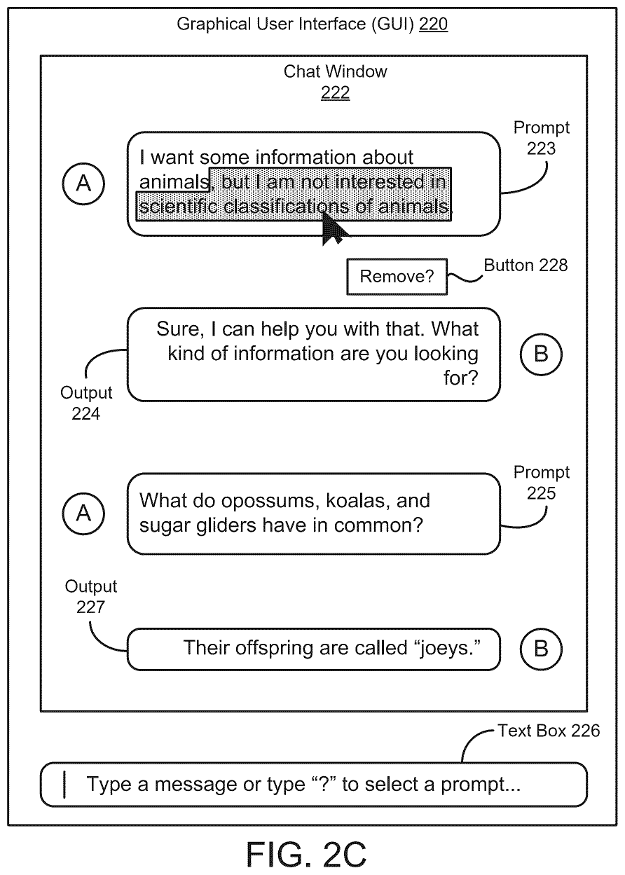

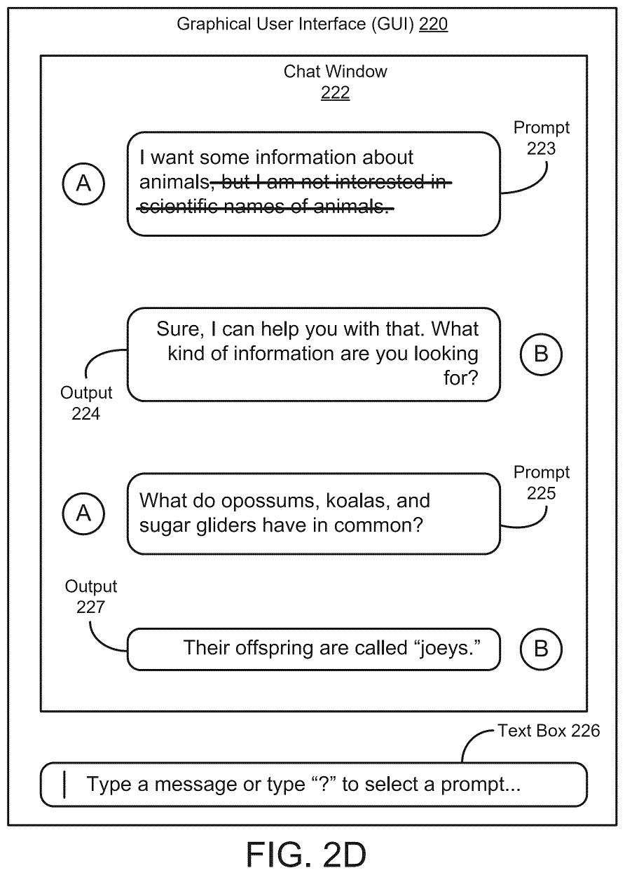

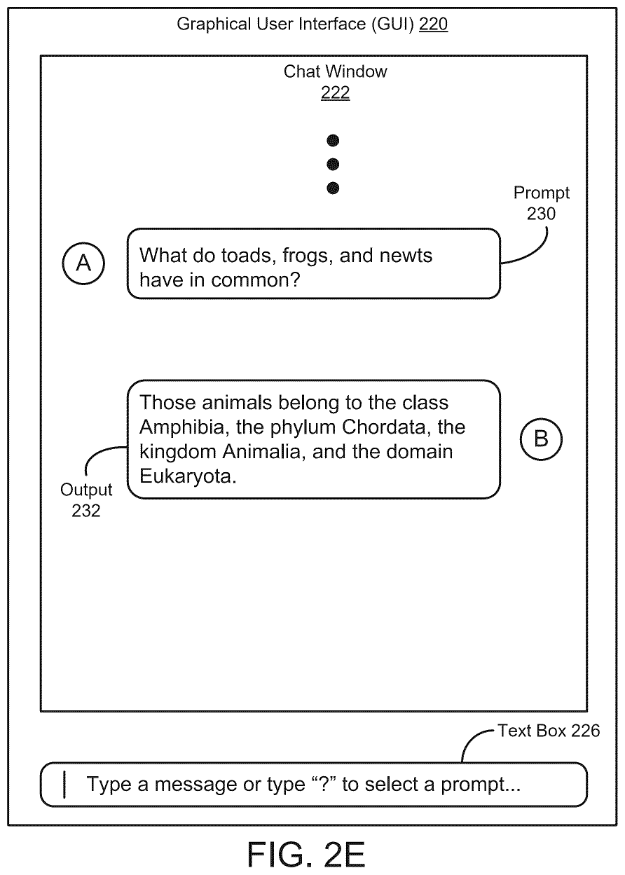

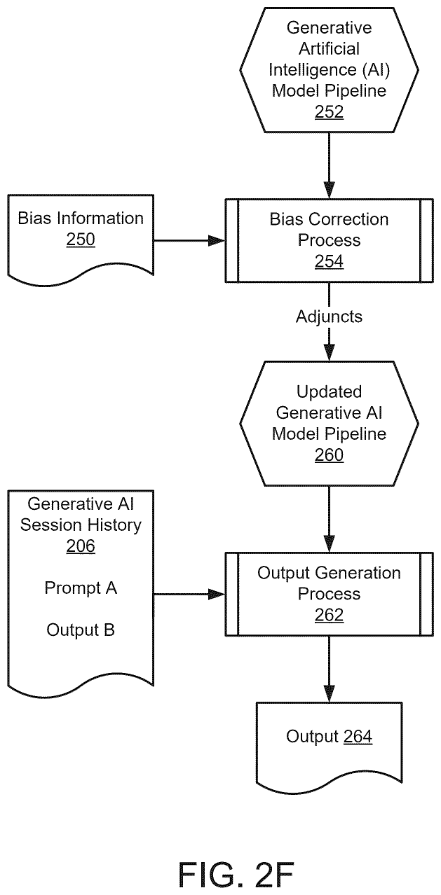

To provide un-inferencing functionality for generative AI models, data processing systems 100 may: (i) obtain, from downstream consumer 106A, a request to un-inference information content (e.g., from a generative AI session history for a generative AI model), (ii) temporarily modify, based on the request, the generative AI model to obtain a temporarily updated generative AI model so that outputs generated by the temporarily updated generative AI model are less influenced by the information content, (iii) obtain, from the temporarily updated generative AI model and based on the generative AI session history, an output, (iv) provide computer-implemented services to the downstream consumer using at least the output, and/or (v) perform other actions. Temporarily modifying the generative AI model may include updating a generative AI model pipeline based on the generative AI model; therefore, the temporarily updated generative AI model may include an updated generative AI model pipeline. Refer to FIG. 2A for additional details regarding temporarily modifying the generative AI model.

At the conclusion of the chat session, data processing systems 100 may revert the temporarily updated generative AI model to the generative AI model (e.g., internal modifications such as maskings may be removed) so that future chat sessions may not be impacted by the modifications to the generative AI model. Refer to FIGS. 2B-2E for an example of a chat session during which information content of a portion of the generative AI session history is un-inferenced.

To manage bias in outputs of the generative AI models while providing the computer-implemented services, data processing systems 100 may: (i) make identifications of occurrences of bias correction events for a generative AI model pipeline based on the generative AI model, (ii) identify information content to un-inference for in the generative AI model pipeline, (iii) update the generative AI model pipeline based on the information content, (iv) obtain, using the generative AI model pipeline, an output, (v) provide a portion of the computer-implemented services using at least the output, and/or (vi) perform other actions.

The occurrences of the bias correction events may be identified based on input from a downstream consumer and/or another entity. For example, the downstream consumer may (i) initiate a request to un-inference information content from an output of a generative AI model (e.g., information content of an output from a generative AI model session history for the generative AI model), and/or (ii) provide a prompt (e.g., to the generative AI model session history) indicating information content expressing a bias that is to be un-inferenced for. For example, the information content may be based on a known bias of the generative AI model.

The generative AI model pipeline may be updated, for example, by obtaining, based on the information content, embeddings and/or negation layers as adjuncts for the generative AI model (e.g., layers and/or attention modules thereof). The embeddings and/or negation layers may be used to update the generative AI model pipeline so that outputs generated by the updated generative AI model pipeline are less influenced by the information content, thereby reducing (e.g., removing) any associated bias. Refer to the discussion of FIG. 2F for more details regarding bias correction using un-inferencing.

AI model manager 102 may manage any number of AI models. For example, AI model manager 102 may: (i) obtain training data for AI models, (ii) train any number of AI models to obtain trained AI models, (iii) deploy trained AI models to other entities (e.g., data processing systems 100), (iv) update and/or modify trained AI models (e.g., fine-tune trained AI models based on additional training and/or production data), and/or (v) provide other AI model management services.

For example, AI model manager 102 may cooperatively provide at least a portion of the computer-implemented services to data processing systems 100 by: (i) obtaining training data from downstream consumers 106, (ii) training one or more AI models (e.g., generative AI models) using at least the training data obtained from downstream consumers 106 to obtain one or more trained AI models, (iii) deploying the one or more trained AI models to data processing systems 100 for use in providing output generation services for downstream consumers 106, and/or (iv) performing other actions.

Downstream consumers 106 may provide and/or consume all, or a portion of, the computer-implemented services. Downstream consumers 106 may include any number of downstream consumers (e.g., 106A-106N) and may include, for example, businesses, individuals, and/or devices (e.g., data processing systems) that may obtain outputs and/or other information based on the outputs as part of receiving the computer-implemented services.

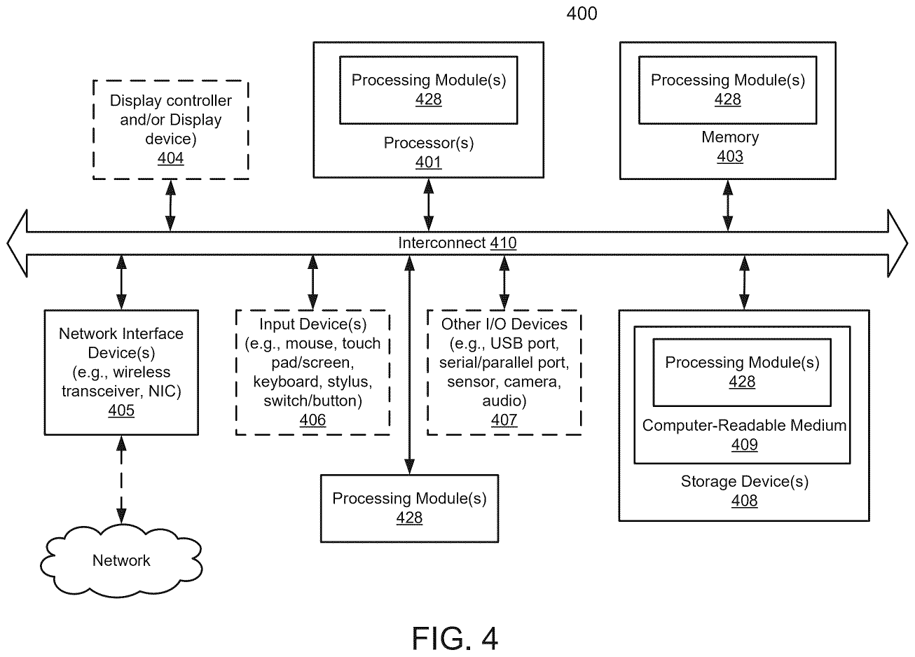

Any of (and/or components thereof) data processing systems 100, AI model manager 102, and downstream consumers 106 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to the discussion of FIG. 4.

Any of the components illustrated in FIG. 1 may be operably connected to each other (and/or components not illustrated) with communication system 104. In an embodiment, communication system 104 includes one or more networks that facilitate communication between any number of components. The networks may include wired networks and/or wireless networks (e.g., and/or the Internet). The networks may operate in accordance with any number and types of communication protocols (e.g., such as the internet protocol).

Communication system 104 may allow any of data processing systems 100, AI model manager 102, and downstream consumers 106 to communicate with one another (and/or with other devices not illustrated in FIG. 1). To provide its functionality, communication system 104 may be implemented with one or more wired and/or wireless networks. Any of these networks may be a radio access network (e.g., a cellular core network), a private network (e.g., the “Network” shown in FIG. 4), a public network, and/or may include the Internet. For example, data processing systems 100 may be operably connected to AI model manager 102 and downstream consumers 106 via the Internet. Data processing systems 100, AI model manager 102, downstream consumers 106, and/or communication system 104 may be adapted to perform one or more protocols for communicating via communication system 104.

While illustrated in FIG. 1 as including a limited number of specific components, a system in accordance with an embodiment may include fewer, additional, and/or different components than those illustrated therein.

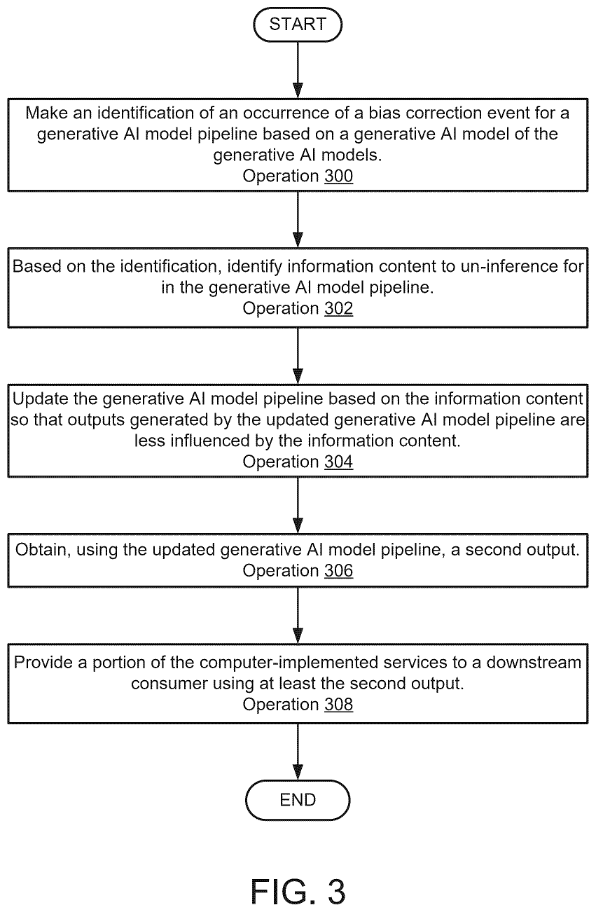

While providing their functionality, any of data processing systems 100, AI model manager 102, and/or downstream consumers 106 may provide all or a portion of the methods shown in FIGS. 2A-3.

To further clarify embodiments disclosed herein, data flow diagrams in accordance with an embodiment are shown in FIG. 2A and FIG. 2F. In these diagrams, flows of data and processing of data are illustrated using different sets of shapes. A first set of shapes (e.g., 200, 206) is used to represent data structures, a second set of shapes (e.g., 204, 212) is used to represent processes performed using and/or that generate data, and a third set of shapes (e.g., 202, 210) is used to represent generative AI models, other types of models, and/or generative AI pipelines (e.g., executing instances of the generative AI models).

Turning to FIG. 2A, a first data flow diagram in accordance with an embodiment is shown. The first data flow diagram may illustrate data used in and data processing performed in providing computer-implemented services using at least an output generated by a temporarily updated generative AI model.

As part of providing the computer-implemented services, a downstream consumer (e.g., 106A) may initiate a chat session (e.g., with an AI agent hosted by one or more of data processing systems 100). During the chat session, the downstream consumer may provide prompts (not shown) and the AI agent may provide responses (e.g., outputs generated by a generative AI model based on the prompts). During the chat session, the downstream consumer may select information content to be un-inferenced from the generative AI session history (e.g., including prompts provided during the chat session).

Request 200 may be obtained from the downstream consumer and may include an indication of the information content that is requested to be un-inferenced from generative AI session history 206. Generative AI session history 206 may include: (i) prompt A, and (ii) output B. Prompt A may have been provided by the downstream consumer during the chat session and may have been used to generate output B (e.g., by the generative AI model).

Request 200 may be provided, by the downstream consumer, via an interaction with a graphical user interface (GUI) (not shown, refer to FIGS. 2B-2E for an example GUI). The GUI may display, to the downstream consumer, a record of the chat session that includes generative AI session history 206. The GUI may also include functionality for the downstream consumer to select (e.g., using human interface devices such as a mouse and a keyboard) portions of generative AI session history 206 that are desired to be un-inferenced.

Selecting the portions of generative AI session history 206 may include: (i) highlighting a prompt, (ii) entering a command (e.g., to initiate a selection mode and/or to enter request 200), (iii) selecting a button on the GUI, and/or (iv) other actions.

Output B may be generated by feeding prompt A into generative AI model 202. For example, an AI agent (e.g., a software program) may facilitate providing prompt A to generative AI model 202, and populating a chat window of the GUI using output B.

Generative AI model 202 may be an LLM (e.g., a neural network inference model) trained to generate language, understand language, and/or otherwise process requests related to languages. Generative AI model 202 may have been previously trained using training data and any training process (e.g., a global optimization process using gradient descent), the training data indicating goals for outputs generated by generative AI model 202 (e.g., outputs). Parameters of generative AI model 202 may be selected using an optimization process (e.g., an objective function may be defined in terms of the training data and outputs generated by generative AI model 202, and a global optimization method such as gradient descent may be used to identify parameters that most faithfully reproduce the trends in the training data). Once the parameters of generative AI model 202 are set, then generative AI model 202 may be used to generate outputs (e.g., responses) based on input data (e.g., prompts). Generative AI model 202 may be trained using other methods without departing from embodiments disclosed herein. Generative AI model 202 may include a generative AI pipeline based on generative AI model 202.

To un-inference the portion of generative AI session history 206, temporary AI model modification process 204 may be performed. During temporary AI model modification process 204, modifications may be made to an internal state of generative AI model 202 to obtain temporarily updated generative AI model 210 (e.g., a modified instance of generative AI model 202). The modifications may be made based on the information content indicated by request 200.

Making modifications to the internal state of generative AI model 202 may include: (i) adding, based on request 200, embeddings (e.g., negated embeddings) corresponding to the information content that is desired to be un-inferenced to obtain temporarily updated generative AI model 210 (e.g., identifying the embeddings and zero masking the embeddings so they are ignored when ingested), (ii) removing (e.g., deleting) tokens that correspond to the information content from a memory (e.g., attention) of generative AI model 202, (iii) adding, based on request 200, a negation layer as an adjunct for generative AI model 202 to obtain temporarily updated generative AI model 210, (iv) adding, based on request 200, a negation layer as an adjunct for generative AI model 202 that feeds into an attention module of generative AI model 202 to obtain temporarily updated generative AI model 210, and/or (v) adding, based on request 200, a negation layer as an adjunct for a hidden layer of an attention module of generative AI model 202 to obtain temporarily updated generative AI model 210.

The negation layers may be placed so that information content corresponding to the portion of generative AI session history 206 that is desired to be un-inferenced (e.g., sequences of tokens similar to and/or the same as tokens of the portion of generative AI session history 206 that is desired to be un-inferenced) pass through the negation layers at different points in the architecture of temporarily updated generative AI model 210 (e.g., prior to or after the input layer, prior to the attention module, in a hidden layer of the attention module). Therefore, when the same and/or similar tokens pass through the negation layers, operations may be performed to modify the values of the tokens.

Temporarily updated generative AI model 210 may, therefore, include one or more of the above modifications thereby reducing an impact of the information content on future outputs generated by temporarily updated generative AI model 210.

Temporarily updated generative AI model 210 and generative AI session history 206 may be used to perform output generation process 212 to obtain output 214. During output generation process 212, generative AI session history 206 may be fed into temporarily updated generative AI model 210 to generate output 214 as output. However, temporarily updated generative AI model 210 may include one or more negations (e.g., negation layers, masked embeddings) so that information content of output B is un-inferenced from an internal state of temporarily updated generative AI model 210 and so that output B may have a reduced impact on output 214.

At the conclusion of the chat session, temporarily updated generative AI model 210 may be reverted to generative AI model 202 so that future chat sessions are not impacted by request 200. For example, any negation layers of temporarily updated generative AI model 210 may only impact tokens of the input that was desired to be un-inferenced from the generative AI session history and, consequently, the negation layers may not impact new input data (e.g., temporarily updated generative AI model 210 may not require active reversion to generative AI model 202). If any zero masking or manual deletion of portions of memory of generative AI model 202 was performed, a memory wipe may be performed to remove the zero masks and/or other memory modifications thereby reverting attention values and available contextual information of generative AI model 202 to an internal state prior to the temporary update.

Thus, by implementing the data flows shown in FIG. 2A, a system in accordance with embodiments disclosed herein may be used to un-inference portions of a generative AI session history of a chat session based on requests (e.g., feedback) for un-inferencing of information content from the generative AI session history. By modifying a generative AI model pipeline based on the generative AI model using the feedback, the chat session may continue with a reduced impact of the information content. Consequently, a reliability and/or usefulness of outputs may be increased for the downstream consumer. FIGS. 2B-2E show examples of a GUI that may be used to facilitate un-inferencing of information content.

Turning to FIG. 2B, an example graphical user interface (GUI) is shown. GUI 220 may display at least chat window 222 and text box 226. GUI 220 may be accessible by downstream consumers (e.g., via a website) and may include any number of pop-up interfaces, chat windows, buttons, graphics, and/or other elements through which information may be displayed to a viewer (e.g., a downstream consumer) and/or through which the viewer may interact. Other entities (e.g., an AI agent managing a chat service, a data processing system hosting the AI agent and/or any number of generative AI models) may populate GUI 220 with data intended to be displayed to the downstream consumer.

A downstream consumer may initiate a chat session with an AI agent (e.g., a computer program such as a chatbot) and chat window 222 and text box 226 may be displayed on GUI 220 to the downstream consumer for a duration of the chat session.

A customer may open chat window 222 and may enter prompt 223 into text box 226. Prompt 223 may include the following text: “I want some information about animals, but I am not interested in scientific classifications of animals.” Prompt 223 is shown next to a circle with the letter “A” inside the circle to indicate input from a first entity (e.g., the downstream consumer).

Prompt 223 may be used as ingest for a generative AI model and output 224 may be obtained as output from the generative AI model. The generative AI model (e.g., and/or an AI agent participating in the chat session) may provide output 224 as a response to prompt 223. Output 224 may include the following text: “Sure, I can help you with that. What kind of information are you looking for?” Output 224 is shown next to a circle with the letter “B” inside the circle to indicate input from a second entity (e.g., the AI agent).

The downstream consumer may continue the chat session by typing in additional prompts (e.g., prompt 225) to text box 226. Text box 226, for example, may include a prompt instructing the downstream consumer to “type a message or type “?” to select a prompt . . . ” The downstream consumer may provide prompts and/or commands via other types of interactions with GUI 220 without departing from embodiments disclosed herein.

Prompt 225 may include the text: “What do opossums, koalas, and sugar gliders have in common?” Output 227 may be generated based on the entire generative AI session history (e.g., at least prompt 223, output 224, and prompt 225). Output 227 may include the text: “Their offspring are called “joeys.””

Therefore, the downstream consumer may enter a special character or command (e.g., “?” is shown as an example in FIG. 2B) to enable functionality to select a portion of prompt 223 for un-inferencing from a generative AI session history of the chat session. Enabling selection information content for un-inferencing may be performed via other commands, other interactions, and/or other processes without departing from embodiments disclosed herein.

Turning to FIG. 2C, the downstream consumer may type in the command “?” in text box 226 to enable selection of a portion of prompt 223 (not shown). The downstream consumer may highlight, using a cursor on a display controlled by a human interface device such as a mouse, a portion of prompt 223.

For example, in FIG. 2C, the portion “, but I am not interested in scientific classifications of animals” has been highlighted on chat window 222 using a cursor. While shown with respect to highlighting a portion of prompt 223, portions of prompt 223 may be selected via other methods without departing from embodiments disclosed herein.

After selecting the text “, but I am not interested in scientific classifications of animals,” button 228 may appear next to the selected text. If the downstream consumer selects button 228, the information content related to the highlighted portion of prompt 223 may be un-inferenced from the generative AI session history of the chat session.

The generative AI model used to generate output 224 and output 227 may be temporarily modified so that outputs generated by the temporarily updated generative AI model are less influenced by the information content of “, but I am not interested in scientific classifications of animals” for the duration of the chat session (e.g., some latent influence may remain).

Turning to FIG. 2D, the un-inferenced information content of “, but I am not interested in scientific classifications of animals” may be shown in chat window 222 as crossed out to indicate that it has been un-inferenced from the generative AI session history.

Turning to FIG. 2E, a portion of the chat session that occurs after un-inferencing of the portion of prompt 223 may be shown. For example, the three filled in circles at the top of chat window 222 may indicate that other previous portions of the chat session are not shown (e.g., the downstream consumer may scroll up to view them).

Therefore, the downstream consumer may type in prompt 230 and output 232 may be generated by the temporarily updated generative AI model. Prompt 230 may include the text: “What do toads, frogs, and newts have in common?”

Output 232 may include the text: “Those animals belong to the class Amphibia, the phylum Chordata, the kingdom Animalia, and the domain Eukaryota.” Thus, the temporarily updated generative AI model may not have context available indicating that scientific classifications are not to be provided. In this example, a response from the generative AI model that includes a scientific classification of animals may be a “default” response from the generative AI model. If no modifying requests are made in a prompt, the response from the generative AI model may include scientific classifications. Therefore, the impact of the un-inferenced portion of prompt 223 may be reduced for future outputs generated during the chat session.

Thus, FIGS. 2B-2E show an example GUI and an example of a chat session between a downstream consumer and a backend system (e.g., an entity that hosts and/or operates generative AI models). It may be appreciated that the GUI may include other elements and information may be provided by the downstream consumer to the backend system via other methods without departing from embodiments disclosed herein.

Turning to FIG. 2F, a second data flow diagram in accordance with an embodiment is shown. The second data flow diagram may illustrate data used in and data processing performed in active management of bias in outputs from generative AI model pipelines.

As discussed with respect to FIG. 2A, a downstream consumer may initiate a generative AI session (e.g., a chat session) with an AI agent, during which the AI agent may provide responses to prompts from the downstream consumer. The responses may include outputs generated by generative AI model pipeline 252. Generative AI model pipeline 252 may be based on a generative AI model, such as generative AI model 202 of FIG. 2A. For example, generative AI model pipeline 252 may include an executing instance of the generative AI model.

During the generative AI session, an identification of an occurrence of a bias correction event for generative AI model pipeline 252 may be made. For example, the occurrence of the bias correction event may include obtaining input from the downstream consumer indicating that information content that expresses a bias that the downstream consumer would like to reduce during the generative AI session.

In a first example, the downstream consumer may notice a bias in an output of the generative AI session history. The user may select information content from a portion of the output and request that the information content be un-inferenced from the generative AI session history. The request may indicate that the output expresses undesirable levels of bias. The request may be similar to request 200 of FIG. 2A, and may be from a downstream consumer (e.g., a user of the chat session) that provided a prompt for which the output was generated.

In a second example, the downstream consumer may have prior knowledge of a bias of the generative AI model, such as a bias identified based on prior interactions with the generative AI model (e.g., the bias may be enforced using a pre-prompt, the bias may be introduced during training of the generative AI model). The downstream consumer may provide a prompt (to the generative AI session) that negates information content corresponding to the bias (e.g., information content of the pre-prompt) and/or the downstream consumer may provide a statement regarding the bias.

In a third example, the bias correction event may include an initiation of use of the generative AI model pipeline. For example, the use of the generative AI model pipeline may be initiated automatically and/or manually (e.g., by a user). A blueprint for the generative AI model pipeline may define operation of the generative AI model pipeline and may require active debiasing of outputs generated by the generative AI model pipeline. For example, the blueprint may indicate known biases of the generative AI model, and debiasing information may be saved as a component of the blueprint.

Based on the identification of the occurrence of the bias correction event, information content to un-inference for in the generative AI model pipeline may be identified. For example, (i) the input from the downstream consumer (e.g., a request, a prompt) may indicate information content for removal from the generative AI session history and/or (ii) the blueprint for the generative AI model pipeline may indicate information content, activity of the model, and/or otherwise undesired behavior that, if included in or demonstrated by the generative AI session, should be un-inferenced (e.g., and thereby address the undesired activity or behavior). The information content may be associated with a bias that conflicts with personal values of the downstream consumer and/or others. Therefore, to reduce a likelihood of future outputs expressing similar bias, the information content may be un-inferenced for.

To reduce the influence of the information content on subsequent outputs provided during the generative AI session, bias correction process 254 may be performed. During bias correction process 254, bias information 250 may be used to generate adjuncts for the generative AI model.

Bias information 250 may indicate the information content for un-inferencing. For example, bias information 250 may include (i) the information content, (ii) a negative information attribution for the information content, (iii) a statement regarding a bias indicated by the information content, and/or (iv) other information. Bias information 250 may be generated in response to making the identification of the occurrence of the bias correction event, and may be based on information in input from the downstream consumer and/or a bias component of the blueprint for the generative AI model pipeline.

The information content for un-inferencing may be defined, at least in part, by the statement regarding the bias, and the negative information attribution to the information content. For example, the downstream consumer may select the information content via a GUI displaying the generative AI model session history to indicate that the information content should be un-inferenced for. If a statement regarding the bias is not well defined in the information content, then the statement may be added (e.g., by the downstream consumer, an automated system) to define the bias expressed in the information content.

The negative information attribution may indicate that the information content is to be un-inferenced. Therefore, during bias correction process 254, an adjunct may be obtained to facilitate un-inferencing of the information content. The adjuncts may be usable to negate the information content (e.g., remove the information content from the generative AI session history) and may include embeddings, negation layers, and/or other information. For examples of adjuncts, refer to the discussion of temporary AI model modification process 204 of FIG. 2A.

The adjuncts may be added to (e.g., included in) generative AI model pipeline 252 to obtain updated generative AI model pipeline 260. Once added, the adjuncts may cause updated generative AI model pipeline 260 to treat the information content as negative information content during generation of subsequent outputs, thereby reducing the influence of the information content on the subsequent outputs.

Using updated generative AI model pipeline 260, output generation process 262 may be performed. Output generation process 262 may be similar to output generation process 212 of FIG. 2A. For example, during output generation process 262, generative AI session history 206 may be provided to updated generative AI model pipeline 260.

Consider a first example where the downstream consumer is aware of a bias in outputs from a generative AI model pipeline (e.g., 252). The downstream consumer may provide input (e.g., prompt A of generative AI session history 206) including instructions to un-inference for the bias. Based on the instructions, one or more adjuncts may be generated and added to the generative AI model pipeline to obtain an updated generative AI model pipeline (e.g., 260).

Consider a second example where the downstream consumer is aware of a bias enforced on outputs from the generative AI model pipeline by a pre-prompt. The downstream consumer may provide input to trigger the pre-prompt and/or input stating the bias in the pre-prompt is to be un-inferenced for. Based on the input, one or more adjuncts may be generated and added to the generative AI model pipeline to obtain an updated generative AI model pipeline (e.g., 260).

Consider a third example where the downstream consumer notices a bias based on information content of an output from the generative AI model pipeline (e.g., output B of generative AI session history 206). The downstream consumer may indicate that the information content expresses an undesirable level of bias. To do so, the user may select the information content for un-inferencing, thereby initiating generation of a request for un-inferencing for the information content. The user may provide a prompt including a statement regarding the bias. Based on the request and the prompt, one or more adjuncts may be generated and added to the generative AI model pipeline to obtain an updated generative AI model pipeline (e.g., 260).

Thus, one or more adjuncts may be included in updated generative AI model pipeline 260 to handle the information content for an internal state of updated generative AI model pipeline 260 during generation of output 264. By doing so, the information content expressing the bias (e.g., the information content of output B, the pre-prompt, the internal state of the generative AI model) may have a reduced impact on output 264, thereby reducing a likelihood of output 264 expressing the undesirable level of bias.

Output 264 may be provided to the downstream consumer via the chat session as a portion of the computer-implemented services. For example, output 264 may be used by the downstream consumer (e.g., in place of output B) to make unbiased decisions (and/or decisions having reduced bias).

Thus, by implementing the data flows shown in FIG. 2B, a system in accordance with embodiments disclosed herein may be used to actively manage bias in outputs from generative AI model pipelines using un-inferencing. By doing so, the outputs may be more likely to meet the needs of downstream consumers, thereby improving a quality of the computer-implemented services provided using the generative AI models.

In FIG. 2A and FIG. 2F, any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

In FIG. 2A and FIG. 2F, any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

In FIG. 2A and FIG. 2F, any of the data structures illustrated using the first set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to manage a data processing system. FIG. 3 illustrates methods that may be performed by the components of the system of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of providing computer-implemented services using generative AI models in accordance with an embodiment is shown. The method may be performed, for example, by any of the components of the system of FIG. 1, and/or other components not shown therein.

At operation 300, an identification of an occurrence of a bias correction event for a generative AI model pipeline based on a generative AI model of the generative AI models may be made. The identification may be made by: (i) obtaining input (e.g., from a downstream consumer) indicating a bias of the generative AI model pipeline, (ii) obtaining a notification indicating initiation of use of the generative AI model pipeline, and/or (iii) other methods. For example, the occurrence of the bias correction event may be identified based on a request indicating that a first output from the generative AI model pipeline expresses undesirable levels of bias.

In a first example, a downstream consumer of outputs of the generative AI model pipeline may enter the input via a GUI (e.g., a generative AI model session) using any number of human interface devices operably connected to a device operated by the downstream consumer, and generation of the request may be treated as the occurrence of the bias correction event.

In a second example, use of the generative AI model pipeline may be initiated (e.g., by a program such as an AI agent, by a user), and the initiation may be detected and treated as the occurrence of the bias correction event.

At operation 302, based on the identification, information content to un-inference for in the generative AI model pipeline may be identified. The information content may be identified by: (i) reading the information content (e.g., from storage), (ii) receiving the information content (e.g., from another entity), (iii) providing information (e.g., the request and/or the notification indicating the initiation of use) to an entity responsible for identifying information content to un-inference for based on the information, (iv) parsing the information content from the input (e.g., the request) and/or the notification, and/or (v) other methods.

At operation 304, the generative AI model pipeline may be updated based on the information content so that outputs generated by the updated generative AI model pipeline are less influenced by the information content. The generative AI model pipeline may be updated by obtaining an adjunct based on the information content to update how the information content is treated by the generative AI model pipeline and/or other methods.

Updating the generative AI model pipeline may include: (i) adding, based on the information content, embeddings corresponding to the information content to the generative AI model pipeline, (ii) adding, based on the information content, a negation layer as an adjunct for the generative AI model to the generative AI model pipeline, (iii) adding, based on the information content, a negation layer as an adjunct for the generative AI model that feeds into an attention module of the generative AI model pipeline, (iv) adding, based on the information content, a negation layer as an adjunct for a hidden layer of an attention module of the generative AI model pipeline, and/or (v) other methods.

Adding the embeddings to the generative AI model pipeline may include: (i) obtaining the embeddings corresponding to the information content (e.g., reading the embeddings from storage, obtaining the embeddings from another entity), (ii) negating the embeddings and adding the negated embeddings as an adjunct to the generative AI model pipeline, (iii) zero masking the embeddings from (e.g., so that they are ignored when processed), and/or (iv) other methods.

Adding the negation layer as the adjunct to the generative AI model pipeline may include: (i) identifying elements (e.g., neurons) of an input layer of the generative AI model pipeline that consume the information content, (ii) performing an operation to modify a latent representation of the information content prior to or following ingestion by the neurons of the input layer, and/or (iii) other methods. Modifying the latent representation may include changing attention values of the input (e.g., multiplying the attention values by negative one). By doing so, the information content may be processed in a negated form (e.g., by the input layer, by a layer of neurons after the input layer).

Adding the negation layer (e.g., a layer that performs the modification of the information content) as the adjunct to the generative AI model pipeline that feeds into the attention module may include methods similar to those described with respect to adding the negation layer to the input layer. However, the negation layer may be added to elements of the generative AI model that are located prior to an attention module of the generative AI model rather than in the input layer. Therefore, partially processed input data may pass through the negation layer prior to entering the attention module (e.g., attention layer) and/or after exiting the attention module.

Adding the negation layer as the adjunct for the hidden layer of the attention module may include methods similar to those described with respect to adding the negation layer to the input layer. However, the negation layer may be added within a hidden layer of the attention module rather than to the input layer. Therefore, partially processed input data may enter the attention module, pass through the negation layer at some point within the attention module, and may exit the attention module having passed through the negation layer.

At operation 306, a second output may be obtained using the updated generative AI model pipeline. The second output may be obtained by: (i) reading the second output (e.g., from storage), (ii) receiving the second output (e.g., from another entity via a communication system), (iii) generating the second output, and/or (iv) other methods. The updated generative AI model pipeline may treat the information content as negative information content during generation of the second output.

For example, the second output may be generated by feeding a generative AI session history of the generative AI model pipeline into the updated generative AI pipeline and obtaining a response from the updated generative AI pipeline based on the prompt. Obtaining the second output may include providing the generative AI session history to an entity responsible for operating the generative AI model pipeline, and receiving a response from the entity.

At operation 308, a portion of the computer-implemented services may be provided using at least the second output. Providing the portion of the computer-implemented services may include: (i) providing a data package including the second output to a downstream consumer and/or another entity (e.g., via transmission via message and/or other methods), (ii) populating a GUI with at least the second output (e.g., as part of a chat session), (iii) making decisions based on at least the second output, (iv) selecting one or more actions based on the second output and performing the one or more actions to update operation of a system, and/or (v) other methods.

The method may end following operation 308.

Thus, as illustrated above, embodiments disclosed herein may provide systems and methods usable to provide computer-implemented services using generative AI models. By updating a generative AI pipeline to treat information content expressing an undesirable level of bias as negative information content during generation of outputs, the outputs may be less likely to include bias. Consequently, a likelihood of the outputs generated by the updated generative AI pipeline meeting needs of the downstream consumer may be increased.

Any of the components illustrated in FIGS. 1-2F may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for providing computer-implemented services using generative artificial intelligence (AI) models, the method comprising:
making an identification of an occurrence of a bias correction event for a generative AI model pipeline based on a generative AI model of the generative AI models; and
based on the identification:
identifying information content to un-inference for in the generative AI model pipeline,
updating the generative AI model pipeline based on the information content so that outputs generated by the updated generative AI model pipeline are less influenced by the information content,
obtaining, using the updated generative AI model pipeline, a second output, and
providing a portion of the computer-implemented services using at least the second output.

2. The method of claim 1, wherein updating the generative AI model pipeline comprises:
adding, based on the information content, embeddings corresponding to the information content to the generative AI model pipeline.

3. The method of claim 1, wherein updating the generative AI model pipeline comprises:
adding, based on the information content, a negation layer as an adjunct for the generative AI model to the generative AI model pipeline.

4. The method of claim 1, wherein updating the generative AI model pipeline comprises:
adding, based on the information content, a negation layer as an adjunct for the generative AI model that feeds into an attention module of the generative AI model pipeline.

5. The method of claim 1, wherein updating the generative AI model pipeline comprises:
adding, based on the information content, a negation layer as an adjunct for a hidden layer of an attention module of the generative AI model pipeline.

6. The method of claim 1, wherein the bias correction event is a request indicating that a first output from the generative AI model pipeline expresses undesirable levels of bias.

7. The method of claim 6, wherein the request is from a user that provided a prompt for which the first output was generated.

8. The method of claim 1, wherein the bias correction event is an initiation of use of the generative AI model pipeline, and a blueprint for the generative AI model pipeline requires active debiasing of outputs generated by the generative AI model pipeline.

9. The method of claim 1, wherein the updated generative AI model pipeline treats the information content as negative information content during generation of the second output.

10. The method of claim 9, wherein the information content is defined, at least in part, by a statement regarding a bias, and a negative information attribution to the information content.

11. The method of claim 10, wherein the negative information attribution indicates that the information content is to be un-inferenced.

12. The method of claim 1, wherein the generative AI model is a large language model (LLM).

13. A non-transitory machine-readable medium having instructions stored therein, which when executed by a processor, cause the processor to perform operations for providing computer-implemented services using generative artificial intelligence (AI) models, the operations comprising:
making an identification of an occurrence of a bias correction event for a generative AI model pipeline based on a generative AI model of the generative AI models; and
based on the identification:
identifying information content to un-inference for in the generative AI model pipeline,
updating the generative AI model pipeline based on the information content so that outputs generated by the updated generative AI model pipeline are less influenced by the information content,
obtaining, using the updated generative AI model pipeline, a second output, and
providing a portion of the computer-implemented services using at least the second output.

14. The non-transitory machine-readable medium of claim 13, wherein updating the generative AI model pipeline comprises:
adding, based on the information content, embeddings corresponding to the information content to the generative AI model pipeline.

15. The non-transitory machine-readable medium of claim 13, wherein updating the generative AI model pipeline comprises:
adding, based on the information content, a negation layer as an adjunct for the generative AI model to the generative AI model pipeline.

16. The non-transitory machine-readable medium of claim 13, wherein updating the generative AI model pipeline comprises:
adding, based on the information content, a negation layer as an adjunct for the generative AI model that feeds into an attention module of the generative AI model pipeline.

17. A data processing system, comprising:
a processor; and
a memory coupled to the processor to store instructions, which when executed by the processor, cause the processor to perform operations for providing computer-implemented services using generative artificial intelligence (AI) models, the operations comprising:
making an identification of an occurrence of a bias correction event for a generative AI model pipeline based on a generative AI model of the generative AI models; and
based on the identification:
identifying information content to un-inference for in the generative AI model pipeline;
updating the generative AI model pipeline based on the information content so that outputs generated by the updated generative AI model pipeline are less influenced by the information content;
obtaining, using the updated generative AI model pipeline, a second output; and
providing a portion of the computer-implemented services using at least the second output.

18. The data processing system of claim 17, wherein updating the generative AI model pipeline comprises:
adding, based on the information content, embeddings corresponding to the information content to the generative AI model pipeline.

19. The data processing system of claim 17, wherein updating the generative AI model pipeline comprises:
adding, based on the information content, a negation layer as an adjunct for the generative AI model to the generative AI model pipeline.

20. The data processing system of claim 17, wherein updating the generative AI model pipeline comprises:
adding, based on the information content, a negation layer as an adjunct for the generative AI model that feeds into an attention module of the generative AI model pipeline.
